(19) United States
(12) Patent Application Publication
(10) Pub. No.: US 2004/0111361 A1
(43) Pub. Date: Jun. 10, 2004

(54) System and method for value delivery

(75) Inventors: Patience Griffiths, Verona, NJ (US); Sandra Angevine, Pelham, NY (US); Kathleen Krier, Upland, CA (US); Chris Hylen, Manhattan Beach, CA (US); Kristin Walle, Long Beach, CA (US)

Correspondence Address: Doreen J. Gridley, ICE MILLER, One American Square, Box 82001, Indianapolis, IN, 46282-0002, US

(73) Assignee: Automatic Data Processing, Inc., Roseland, NJ

(21) Appl. No.: 10/295,648

(22) Filed: Nov. 15, 2002

(51) Int. Cl. G06F 17/60

(52) U.S. Cl. 705/39; 705/42; 705/30

(57) ABSTRACT

A system and method for providing a monetary equivalent from a payor to at least one payee. The monetary equivalent delivered in accordance with the present invention is a stored value card from an account funded, directly or indirectly, from an account of the payor. In some instances, a third party processor is involved to facilitate the transfer of funds to the stored value accounts of the payees. In one embodiment, the payor is an employer and the payees are employees of the payroll, with the invention serving as a vehicle for payroll distribution. A third party processor that may be involved in this embodiment comprises a payroll processor. In another embodiment of the present invention, the employer makes instant payment to certain identified employees. In yet another embodiment, the employer transfers value to one or more payees of the designated employees. The present invention serves all without regard to whether the payee already has any accounts in any financial institution.

### FIELD OF THE INVENTION

This invention relates to a system and method for value delivery, and, more particularly to a system and method for delivery of monetary equivalents to individuals.

### BACKGROUND OF THE INVENTION

The banking industry, and financial institutions in general, has been undergoing a major transformation in the last several decades. Sometime ago, society made a majority of its commercial transactions with cash alone. During such time, the financial institutions provided services focused on cash transactions. For example, to facilitate the provision of cash to its customers, financial institutions made available numerous employees, such as bank tellers, for the exchange of cash with its customers.

The introduction of commercial paper, such as checks, significantly changed the nature of financial transactions. Because not all transactions were based on cash, a purchaser could make payment under more convenient circumstances. Paper trails (records) resulted from the transactions. Because the checks were generally written on secured accounts at a financial institution, a buyer had confidence in the value of this monetary equivalent as payment. For financial institutions, exchanges could be made internally between accounts or with accounts of other institutions, and avoid the significant cost associated with handling cash.

More recently, financial institutions made credit cards available to its customers. In essence, the use of the credit card provided a mechanism for a short term loan to the customer, and, because of the availability of additional technology, transactions could be handled automatically via computer systems resulting in conveniences for the customer, the buyers, and the financial institutions.

Based on the acceptance of credit cards and availability of technology, financial institutions have made efforts to replace checks with stored value cards. Unlike credit cards, stored value cards are usually secured by an account of the stored value card owner, and expenditures with the stored value card are not to exceed the value of that account.

Systems have been developed to facilitate nationwide, and even worldwide, acceptance of credit cards and stored value cards. Associations, such as VISA®, MasterCard®, American Express®, and Discover® have been formed, and those associations develop standards, and define the product, acceptance, and terms and conditions for credit card and/or stored value card transactions.

The availability of the Internet has further revolutionized the business of financial institutions. Transactions can take place over the Internet. Such transactions do not involve the use of cash, commercial paper, credit cards, or stored value cards. Instead, the transactions occur electronically in a purely digital world.

Logically, one might assume that, with the evolution of technology and of new methods for performing commercial transactions, the need for cash has been eliminated or that handling of commercial paper, such as checks, is also antiquated and no longer necessary. Several factors contribute to the fact that, instead, all forms of commercial transactions (cash, commercial paper, credit cards, stored value cards, and Internet (electronic) transactions) are viable and, thus, must be supported by financial institutions.

Consider as an example of the need for all forms of commercial transactions, the transaction of payroll delivery by an employer to its employees. Some employers still pay their employees with cash. While this method of payroll distribution may be convenient and/or desired by some employees, it is not considered convenient and/or desired by other employees, such as those who have financial institution accounts from which the employee performs the bulk of its commercial transactions. Cash payroll is also inefficient and impractical for companies with payrolls of any significant size (either monetarily or due to the number of employees). The cash payroll system makes it difficult for the employer to track its payroll, to correctly collect and report taxes due on employees' income, to take deductions for benefits, and to combat fraud on the part of the employer, the supervisors, or the employees. Also, the use of a cash payroll requires the acquisition and storage of large sums of cash, and is insecure and unworkable in many instances.

Another payroll distribution method involves the use of commercial paper, i.e., the issuance of checks to the employees. In some instances, the employer requires the employee to cash the check with the employer, thereby still giving rise to most of the disadvantages of a cash payroll system except that the employer has better records and is able to accommodate reductions for the payment of taxes and benefits in a trackable manner. The more prevalent check payroll distribution system does not require the employee to cash the check with the employer. Instead, the employee can cash or deposit the check with a financial institution or with an individual or company as desired by the employee.

Check payroll systems still have several shortcomings. If the checks are distributed personally, disruptions in the workplace may result. If the checks are distributed by mail, they may be misplaced or lost. Check payroll systems result in cumbersome recordkeeping, require mechanisms and resources for handling misplaced or lost checks, necessitate the provision of time and resources to cancel the checks and to print replacements, may lead to liability for fraudulently cashed checks, still require the employee to cash or deposit the checks, and does not create an audit trail for the employer. Additionally, some employees are unbanked, i.e., do not have an account at a financial institution, and thus, such an employee has difficulty in converting the commercial paper to cash.

Employers are required to provide payment to the unbanked employees without discount to face value of the check, i.e., the employee must not be charged a fee to cash the check. This requirement means that the employer must maintain a relationship of at least one locally accessible bank for the unbanked employees to cash their checks free of charge. This relationship can be costly for employers that do not use a local bank, or when banks insist that the employer pay the cash checking fees for the unbanked employees. The use of checks add costs for the employer and employee.

Many employers offer employees the opportunity to have their pay deposited directly into one or more accounts of the employee's financial institution(s). The direct deposit method eliminates many of the shortcomings associated with check payroll systems; however, the direct deposit still has its own shortcomings. The employee must have at least one account with a financial institution. As previously mentioned, many people are still unbanked. Thus, the direct deposit system does not serve such unbanked employees. If the employee has an account, he/she is still required to visit a branch of the financial institution or automatic teller machine to access the funds directly deposited by the employer.

If the employee uses checks from the account(s) into which the payroll is deposited, the employee experiences further limitations. Checks are not accepted everywhere, or, if accepted, may require identification requirements. Such identification requirements may include a current credit card which the employee may not possess. Many establishments refuse checks, and writing and recording transactions made with checks are inconvenient and cumbersome. Also, use of checks for payment sent by mail presents its own difficulties.

If the employee has a stored value card for the account(s) into which the direct deposit is made, the employee does gain some advantages. However, the use of stored value cards is not available to unbanked employees. Some stored value cards, such as those offered by a financial institution that is not part of an association, may not be accepted universally. Also, there are often fees associated with maintaining and using a stored value card.

As to the universality of use of checks and stored value cards, those accepting payment may legitimately be concerned about whether the payment is secured, i.e., whether funds exist in the account to support the payment. For this reason, stored value cards were slow to be adopted or accepted. Consider, for example, U.S. Pat. No. 5,025,138, directed toward providing a verifiable line of credit for stored value cards. According to this patent, as of the date of filing, 1984, “the stored value card simply shifts the responsibility on to the consumer to keep the stored value account adequately funded.” (Col. 2, line 67 to Col. 3, line 1). Thus, the invention of this patent was the cash surrender value of assigned life insurance policies for the line of credit of the stored value card. Several other lines of credit or overdrawn protection vehicles have been implemented today to guarantee the availability of funds for transactions made with stored value cards. As a result, stored value cards have gained wider acceptance.

It should be noted that, with regard to the check payroll system and the direct deposit payroll system, employers sometimes engage a third party, a payroll processing company, to prepare the payroll. The use of payroll processors eliminates some of the burden on the employer by placing many of the record keeping and distribution duties on the payroll processor, and avoiding much of the capital or resource expenditures required of the employer to generate or purchase its own payroll system.

In view of the foregoing, for the commercial transaction of payroll processing and distribution, it is desired to provide a system and method that incorporates the advantages and efficiencies of a direct payroll system, while overcoming the shortcomings of a direct payroll system. Thus, such a system and method should be able to be used for the unbanked employee, and to provide a more efficient means of payment than the use of cash, checks, credit cards, or stored value cards as presently utilized. For employers, the desired system and method should also: (a) eliminate or reduce employer exposure to fraud; (b) reduce check handling; (c) reduce costs of payroll distribution; (d) support all employees, regardless of geographic location; and (e) provide such support with consistent fees and employee choice. For employees, the system and method should: (a) provide added security (eliminate need to perform transactions with cash); (b) protect from liability for fraud; (c) expand purchasing power of the employee both as to payors and as to geographic location; (d) provide appropriate record keeping; and (e) work for unbanked employees. Further, financial institutions always are seeking ways to service additional customers and generate additional revenue. It is therefore desired that a payroll distribution system and method accommodate the needs and desires of financial institutions.

Very recently, some vendors have made available to employers additional benefits to their employees with some relation to the employce's pay. Such additional benefits should also be accommodated by the desired payroll system and method. Consider, for example, the payroll deduction plan disclosed in U.S. Pat. No. 6,347,305. This payroll deduction plan allows employers the opportunity to support certain commercial transactions made by the employee via the Internet. Specifically, for selected website vendors pre-approved by the employee, the employee will have the option to make payment through payroll deduction for a purchase from that vendor. The employer may then approve or reject the employee's selection, and, if the employee does approve, deduction(s) is (are) made by the employer from the employee's pay for the purchase. A payroll system and method having the above-desired advantages is also desired to permit the employee to offer such benefits, including more traditional benefits, such as insurance costs, as well as taxes from the employee's pay.

Employers have need to deliver other monetary payments to its employees that is distinct from the delivery of traditional pay. For example, in addition to “normal” pay, an employee might be entitled to wages previously withheld, travel reimbursements, car allowances, tuition payments, and the like. Also, there are instances in which payment is made apart from payroll. Such instant payments may comprise reimbursements, allowances, tuition payments, etc., or maybe desired in the event of departure at termination of an employee at a time other than at the end of a “normal” payroll cycle. Thus, it is desired to provide a system and method for delivery of value from employers to employees that can be utilized for all forms of monetary value to be delivered.

Payroll distribution has been discussed in some detail herein as an example of one type of commercial transaction that, along with the transformation of financial institutions, has also been transformed. The desired improved payroll system and method is also exemplary of the delivery of value, a monetary equivalent, to those who may or may not possess a traditional account with a financial institution. In the instance of the desired payroll system and method, it is desired that a monetary equivalent be delivered to an unbanked employee.

There are other instances when it is desired to deliver a monetary equivalent to an individual that may or may not be unbanked, but may not have an account at the financial institution from which the collateral account exists. For example, parents often need to provide funds to their children when the children are not in the locale of the parent, such as when the child is a student at an educational institution located away from home. Traditionally, the parent may set up a checking account for the student in the locale of the educational institution to provide the student with expendable income, while avoiding the problems associated with checking accounts established in a locale remote to the educational institution. Such local checking accounts are problematic, however, for time is required to add additional funds to the account, the checks may not be accepted by all establishments from which the student makes purchases, and the student may not be of age to use a checking account.

More recently, parents have obtained a credit card for use by the student. The use of credit cards is also problematic. It is difficult for the parent to impose limits on the amount of expenditures. To obtain cash, a cash advance on the credit card is replete with fees, usually imposing interest on the transaction or the entire account as of the date of the cash advance. Thus, it is desired to provide a system and method for delivery of a monetary equivalent to a student (or to any other dependent or financially supported individual) that resolves the shortcomings associated with the provision of a local checking account or credit card to such an individual.

Another example of the need or desire to provide funds to a third party is the provision of a gift of “cash” to an individual. If cash is sent by mail, there is risk that the cash is lost or stolen. Providing a check instead leads to the aforementioned shortcomings of checks, such as the inability to use the check in all establishments, the risk of theft or loss, and the fact that checks may not be accepted in a distant locale, or, if accepted, there is significant delay in the availability of the funds of the check. To deal with some of these issues, some establishments offer gift cards that can be used by the holder to purchase merchandise at that establishment. There is no assurance, however, that the gift card holder is the intended recipient (high risk of theft or loss) and the gift card is limited to use of particular establishments. If an individual makes regular gifts to another, gift cards make it difficult for the giver to provide a useful gift. Therefore, it is desired to provide a system and method for provision of monetary gifts that addresses the shortcomings of gift cards.

There are instances in which an employee may also be an employer. Consider, for example, household help (cleaning, cooking, gardening, child care, etc.) used by such an employee on a regular basis. Such help (payees of the employee) may not always be banked. Thus, it is desired to provide a system and method for delivery of value to an employee, where the value is delivered to one or more payees (probably including the employee) that are to receive a portion of the monetary value delivered to the employee by the employer.

### SUMMARY OF THE INVENTION

The system and method of the present invention provides a mechanism for delivery of a monetary equivalent from at least one payor to at least one payee. Specifically, the present invention permits for establishment and funding of a stored value card account for the at least one payee. In one embodiment, the system and method of the present invention are used for delivery of payroll to employees. In another embodiment, the present invention is used to deliver instant payment from the employer to employees, such as might be desired upon departure or termination of the employee or for payment of reimbursements, allowances, tuition, payments, etc. that are to be delivered to the employee. In yet another embodiment, the system and method of the present invention supports delivery of monetary value from an employer to an employee and the employee's designated payees. Such designated payees may include dependents, gift recipients, family members, or employees of the employee, such as household service providers, for example.

The method of the present invention comprises the steps of establishing a settlement account for the payor. This settlement account is ultimately used to fund the stored value accounts for the payees and may belong to the payor, the payroll processor, or a service provider. The payor then identifies the payees to receive the monetary equivalent, and the value of the monetary equivalent for each payee. Such identification is performed at the discretion and direction of the payor. The settlement account is then funded with an amount at least equal to the total of the identified monetary amount(s) for all payees. Then, each stored value account is updated to reflect the funding available for each of the identified payees. Each stored value account is funded according to the amount identified for that payee.

A stored value card is also issued for each of the identified payees. The stored value card is likely to be issued prior to funding so that the holder of the stored value card will have immediate access to funds in the stored value account due that holder. The stored value cards can be used for transactions, such as withdrawal of cash, purchases, or payment of bills, in accordance with standard practices for stored value cards. If the stored value cards are part of a transaction network supported by an association, the use of the stored value card is not generally limited as to type of transaction or for geography.

The system of the present invention includes a communications network or networks connecting one or more financial institutions. Each of the connected financial institutions possesses a system that is operatively connected to the communications network and are part of the system of the present invention. The systems of the financial institutions are of the type to accept and receive funds for accounts handled by that financial institution. The system further includes a processor accessible by the payor and operatively connected to the communications network. This processor is capable of accepting input from the payor to identify at least one payee that is to receive a monetary equivalent from the payor, and accepting input to identify the monetary amount to be provided to each of such identified payees. Two accounts are also included in the system of the present invention. The first account, a payor account, is established with one of the financial institutions and is funded with an amount at least equal to the identified amounts for all of the payees. The second account, an electronic account, is established for each of the identified payees. The electronic accounts are updated in direct relation to the funds transferred from the payor account on behalf of the payee to each stored value account according to the amount to be delivered to the payee of that stored value account.

Generally, the present invention provides a convenient, efficient vehicle for delivery of a monetary equivalent to an individual for subsequent use by that individual or other individuals given permission for such use. The individual receiving funds does not have to be “banked”, i.e., does not have to have an account at any financial institution, to benefit from the invention. The present invention provides a reliable, secure environment for provision of payment by an employee of dependents or family members allowances, monetary gifts, and to the employee's employees or service providers.

When used in the context of payroll distribution, the present invention provides a myriad of advantages when compared to other payroll and payment distribution systems. For employers, the present invention eliminates or reduces employer exposure to check fraud, reduces or eliminates the need to handle checks, results in a reduction in cost of payroll distribution, supports all employees without regard to geographic location, and provides support with consistent fees and employee choice. In addition, the implementation of a payroll system consistent with the present invention does not interfere with the employer's ability to provide other benefits to its employees. For employees, the system provides added security (eliminating the need to perform transactions with cash), protects from liability for fraud, expands purchasing power, provides appropriate record keeping, and works for unbanked employees. Also, the employee may designate receipt of its monetary amount to one or more payees (probably including the employee), to thereby provide a straight forward mechanism to make payments to dependents, family members, gift recipients, its employees, and its service providers. Financial institutions are provided with another way to service customers (or potential customers) and to generate additional revenue. Further, payroll processors may provide the service to employers, and, if a payroll processor supports several employers, additional cost benefits are provided to the employer by virtue of the volume handled by the payroll processor.

### BRIEF DESCRIPTION OF THE DRAWINGS

FIG. 1 shows a block diagram of the participants in one embodiment of the system and method of the present invention.

FIG. 2 shows a block diagram of the participants in another embodiment of the system and method of the present invention.

FIG. 3 shows a block diagram of one embodiment of the system of the present invention.

FIG. 4 shows a block diagram of one embodiment of a client hierarchy used by the payroll processor according to the system and method of the present invention.

FIG. 5 shows a block diagram of one embodiment of the flow of funds, impound, and settlement according to the present invention.

FIG. 6 shows a block diagram of another embodiment of the flow of funds, impound, and settlement according to the present invention.

FIG. 7 shows a block diagram of embodiments of the impound flow of the present invention.

FIG. 8 shows a block diagram of embodiments of the funds flow of the present invention.

FIG. 9 shows a block diagram of embodiments of the settlement flow of the present invention.

FIG. 10 shows a block diagram of the activation and flow of data for an employer according to one embodiment of the present invention.

FIG. 11 shows a block diagram of the flow of employee data from an employer to the service providers according to one embodiment of the present invention.

FIG. 12 shows a block diagram of the flow of data from an employer to the service providers according to another embodiment of the present invention.

### DETAILED DESCRIPTION OF THE PREFERRED EMBODIMENTS

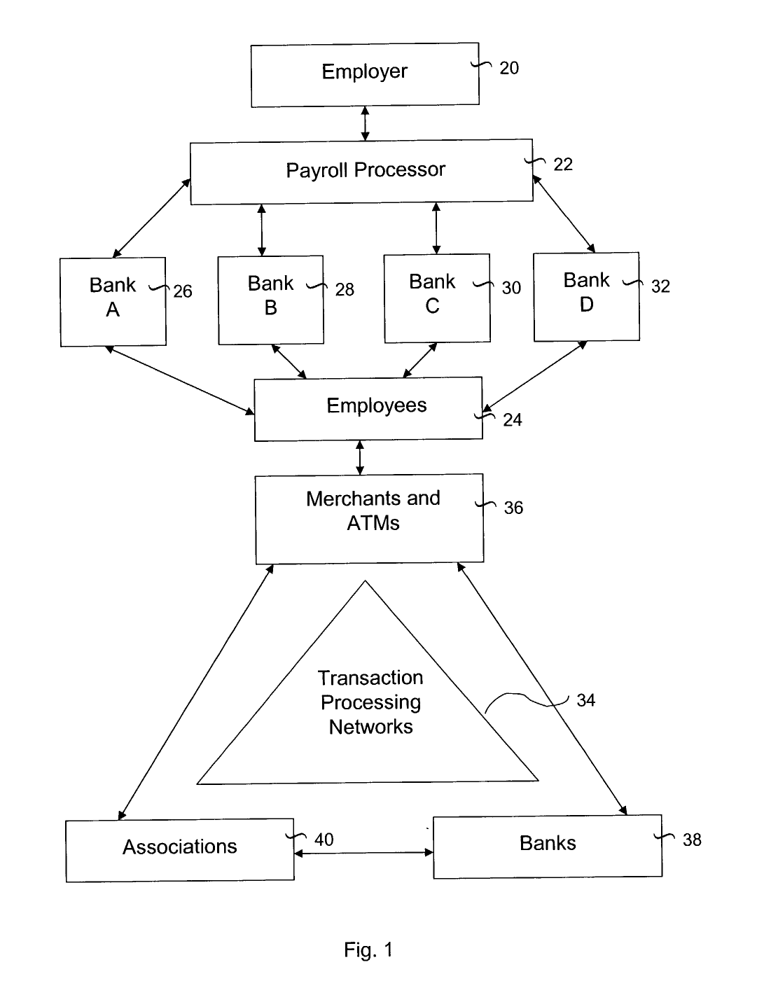

Referring now to FIG. 1, there is shown a block diagram of the participants in one embodiment of the system and method of the present invention. The present invention has applications other than that illustrated in FIG. 1, but FIG. 1 is illustrative of participants in one of those applications. Specifically, the embodiment of FIG. 1 shows the participants in an application of the present invention in which an employer offers its employees the opportunity to receive a monetary equivalent in the form of a store value card (and stored value account) for the pay due the employee. In the embodiment of FIG. 1, employer 20 has at least one employee. For the purpose of handling some or all of the aspects of payroll, employer 20 has engaged the services of payroll processor 22. Payroll processor 22 may be an entity such as ADP, Inc. of Roseland, N.J. who offers a myriad of payroll-related services to employers of various types and sizes.

Employer 20 and payroll processor 22 share information between their respective systems to permit payroll processor 22 to service some or all aspects of the payroll of employer 20. In accordance with the present invention, payroll processor 22 specifically provides employer 20 with a service to permit payroll payment for employees 24 of employer 20 using stored value cards issued on stored value accounts. As explained in greater detail herein, in the event employee 24 leaves the employ of employer 20, the stored value account for that employee 24 is portable, i.e., accessible for other value loads, such as from direct deposit for a future employer. Such a service may or may not be optional, ie., employer 20 may dictate that all its employees be paid by such a service (may be prohibited by applicable law), or employer 20 may offer its employees the option of being paid by such a service.

Regardless of whether the service is optional, employer 20 must share with payroll processor 22 pertinent information about each of employees 24 to be so serviced. Such information is likely to include identification information for the employee (name, address, employee number, and/or social security number, for example). Further, payroll processor 22 must know the amount of pay (the monetary amount) to be delivered to employees 24 by the service. Employer 20 may determine the net pay (gross pay less deductions for taxes, benefits, and the like), due its employees, payroll processor 22 may determine the net pay, or employer 20 and payroll processor 20 may each contribute to determination of the net pay. In any case, employer 20 generally, at its discretion and its direction, determines the net pay due each employee, for it is employer 20 that make benefits available to its employees and employer 20 that collects information about deductions (enrollment for benefits, tax exemptions, additional taxes, etc.) taken from the gross pay of its employees.

As illustrated in FIG. 1, payroll processor 22 has a relationship with and shares information with a plurality of banks. In this embodiment, each of Bank A 26, Bank B 28, Bank C 30, and Bank D 32 cooperate with payroll processor 22 for provision of stored value accounts and the delivery of the stored value cards to employees 24, with each such stored value cards having a monetary value at least equal to the net pay for the respective employee 24. Each of Bank A 26, Bank B 28, Bank C 30, and Bank D 32 have agreed to cooperate with payroll processor 22 in creation and maintenance of the accounts used to deliver the monetary equivalents to employees 24. Each of these accounts is explained in greater detail herein.

To enable the stored value card service to be provided to employees 24, each of Bank A 26, Bank B 28, Bank C 30, and Bank D 32 must communicate (directly or indirectly) with payroll processor 22. Such communication is generally performed by the sharing of information between systems of Bank A 26, Bank B 28, Bank C 30, and Bank D 32 with the system(s) of payroll processor 22. Also, such communication facilitates the funding of accounts handled by the respective bank.

Bank A 26, Bank B 28, Bank C 30, and Bank D 32 each comprise a financial institution. The term financial institution is not limited to a bank, but rather is meant, in the present invention, to comprise an entity capable of authorizing a stored value card account. The financial institution may be isolated, i.e., only issue stored value cards for use with that financial institution. It is more desirable for the benefit of employees 24 for the financial institution to be party to one or more agreements permitting the stored value card to be used at more than one financial institution. It is even more desirable for the financial institution to ascribe to an association, such as VISA®, MasterCard®, American Express®, or Discover®, for example, that have national and even international networks that allow the stored value card to be used with a broader range and larger number of financial institutions.

Each of the financial institutions Bank A 26, Bank B 28, Bank C 30, and Bank D 32, as illustrated in FIG. 1, communicates with employees 24. Such communication is necessary to permit both the financial institution and the employee to be cognizant of the value of the employee's stored value account and any restrictions or conditions related thereto. The financial institution may also desire to communicate with employees 24 to offer other opportunities provided by the financial institution or its affiliates or partners. Communication between the financial institution and the employee may be optional and at the discretion of the employer, employee, and payroll processor.

The communication between the financial institutions and employees 24 may take place between the systems of each, such as when Internet access to account information is provided by a financial institution. Alternately, such communication may take place by other communications tools, such as phone, facsimile, e-mail, or mail, for example. It will be appreciated that not every financial institution needs to have the ability or desire to communicate with all employees 24. Instead, it is likely that employer 22 or each specific employee 24 determines the financial institution to service each of employees 24. The ability of each employee 24 to select the financial institution to handle the stored value account of that employee 24 may be viewed as an additional benefit to that employee 24.

FIG. 1 also illustrates transaction processing network 34 for the purpose of handling commercial transactions performed by the use of the stored value cards issued to employees 24. More than one transaction processing network 34 may accept such stored value cards. Each transaction processing network is generally comprised of at least one association 40. Association 40 maybe, for example, VISA®, MasterCard®, American Express®, or Discover®. Each association 40 generally develops standards, defines products, and defines the term and conditions for commercial transactions handled by transaction processing network 34.

Each transaction processing network 34 also comprises banks (financial institutions) 38, and merchants and automatic teller machines (ATMs) 36. The financial institutions, merchants, and controllers of the ATMs also subscribe to the standards, products, and terms and conditions of association(s) 40 that also comprise transaction processing network 34.

Employees 24 generally perform its commercial transactions with the stored value card through transaction processing network 34. To enable those commercial transactions, the stored value card is presented to a merchant or used at an ATM in a manner well-known in the art. Through the systems of merchants and ATMs 36, banks 38, and Bank A 26, Bank B 28, Bank C 30, and/or Bank D 32, the movement of funds from an employee's stored value account is moved (applied) to the appropriate accounts based on the particular commercial transaction. The movement of funds occurs in a manner well-known in the art of stored value, card and credit card transactions.

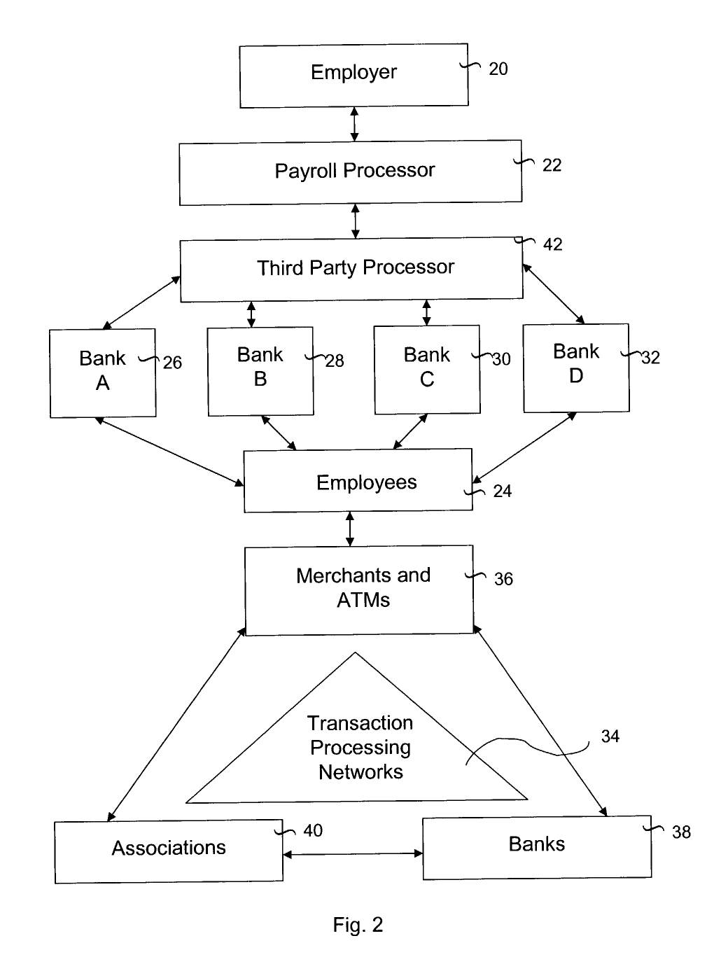

Referring now to FIG. 2, there is shown a block diagram of the participants in another embodiment of the system and method of the present invention. The embodiment of FIG. 2 differs from the embodiment of FIG. 1 by the introduction of third party processor 42. In this embodiment, payroll processor 22 cooperates and communicates with employer 20 for the provision of one or more payroll-related services, including the aforementioned stored value card services. Payroll processor 22 of FIG. 2 does not, however, directly communicate with each of Bank A 26, Bank B 28, Bank C 30, and Bank D 32. Instead, third party processor 42 performs functions such as: (a) establishing accounts for employees 24 at one or more of financial institutions Bank A 26, Bank B 28, Bank C 30, and Bank D 32; (b) issuance of stored value cards for employees 24; (c) authorizing transactions for the stored value cards; (d) provision for employee account statements; and (e) customer service to employees 24. It will be appreciated that any or all of these various services may be performed by payroll processor 22 and the financial institutions (as illustrated in FIG. 1), or a combination of payroll processor 22, one or more third party processors, and one or more financial institutions.

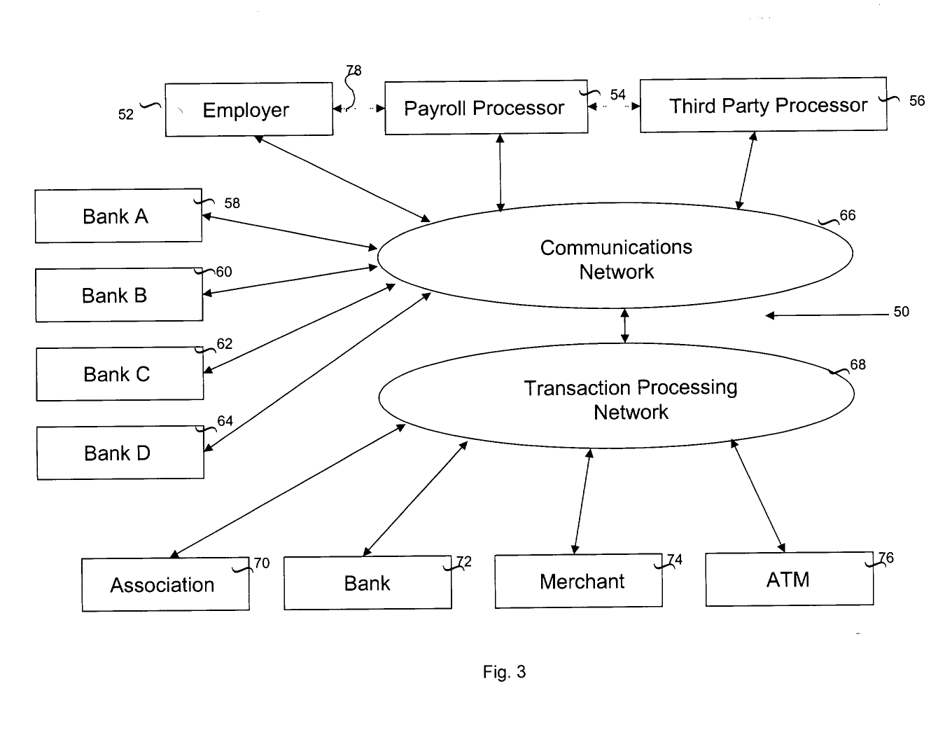

FIG. 3 shows a block diagram of one embodiment of the system of the present invention. In this embodiment, system 50 includes employer system 52, payroll processor system 54, third party processor system 56, Bank A system 58, Bank B system 60, Bank C system 62, Bank D system 64, communications network 66, transaction processing network 68, association system 70, bank system 72, merchant system 74, and ATM 76.

Communications network 66 and transaction processing network 68 may each comprise the Internet (or a portion thereof), another global computer network, a private network, or other bi-directional communications networks well-known in the art. In addition, communications network 66 and transaction processing network 68 may, collectively or each individually, comprise a single network or a plurality of networks. Transaction processing network 68 is likely to include telephonic communications networks as are used by merchants for verification of the stored value cards when used in a transaction.

Employer system 52 comprises hardware and/or software sufficient to permit employer system 52 to communicate with payroll processor system 54. The communication between employer system 52 and payroll processor system 54 may occur directly (such as is illustrated by employer-to-payroll processor connection 78) or via communications network 66. Employer system 52 and payroll processor system 54 must, as previously described, share information about the employees who are to receive the stored value account and stored value card for the value of the employees' net pay. Thus, employer system 52 is likely to comprise a processor and additional hardware and/or software to permit employer system 52 to communicate the identification of such employees and either the gross pay or the net pay due those employees for a particular payroll. Employer systems 52 may comprise a personal computer, and, if employer system 52 communicates with payroll processor system 54 via communications network 66 and communications network 66 comprises the Internet, employer system 52 comprises a browser (such as Netscape or Explorer) together with communications hardware and software to permit employer system 52 to access the Internet.

Payroll processor 54 must be in communication with employer system 52 as previously described. In addition, if the payroll processor does not utilize a third party processor (such as is illustrated in FIG. 1), payroll processor system 54 is in communication with Bank A system 58, Bank B system 60, Bank C system 62, and Bank D system 64. If a third party processor is involved in the provision of services to the employer (such as is illustrated in FIG. 2), payroll processor system 54 must also be in communication with third party processor system 56. Payroll processor system 54 may be connected directly or through communications network to any one or all of employer system 52, third party processor system 56, Bank A system 58, Bank B system 60, Bank C system 62, and Bank D system 64 by communications means well-known in the art.

Payroll processor system 54 comprises hardware and/or software required for communication to employer 52, and for communication with third party processor system 56 or communication with Bank A system 58, Bank B system 60, Bank C system 62, and Bank D system 64. In addition, payroll processor system 54 comprises a processor and other hardware and/or software necessary to provide the stored value card services to the employer. To handle information provided by employer system 52, payroll processor system 54 comprises one or more databases to temporarily or permanently store such information.

Bank A System 58, Bank B system 60, Bank C system 62, and Bank D system 64 each comprise hardware and/or software sufficient to handle (manage, accept funds, disperse funds, etc.) from the stored value accounts established for the employees. In addition, Bank A system 58, Bank B system 60, Bank C system 62, and Bank D system 64 each comprise hardware and/or software sufficient to communicate with either payroll processor system 54 (if no third party processor is participating) or third party processor 56 regarding the identification of employees and the amounts to be deposited in the stored value accounts for the identified employees.

Association system 70, bank system 72, merchant system 74, and ATM 76 each comprise hardware and/or software necessary to provide communication of information required to be shared over transaction processing network 68 for handling commercial transactions made with the stored value cards issued according to the present invention. Such systems are well-known in the art.

To permit the payroll processor to support several employers rather than a single employer as illustrated in FIG. 1, FIG. 2, and FIG. 3, payroll processor system 54 also comprises payroll processing software and at least one database for holding the information related to a particular employer and the employees of that employer that are to be serviced by the payroll processor. Alternatively, such a database may reside with third party processor system 56 (see FIG. 3), or databases containing some or all of such information may reside on payroll processor system 54 and/or third party processor system 56.

It will be appreciated by those of skill in the art that system 50 may also comprise other components and be within the scope of the present invention. Consider, for example, systems connected to communications network 66 to permit employees to review their stored value account information or other information held in system 50. Such systems may include provision of a website or other network node for access electronically by the employee by use of a computer, personal data assistant (“PDA”) such as a Palm Pilot™, or network-ready telephone. Another such system may comprise a telephonic system (with or without voice recognition capability) accessible by the employee. Systems for access (and hence database(s) containing information about at least some of the employees) may be maintained by the payroll processor, the third party processor, or one or more of the financial institutions participating in the present invention.

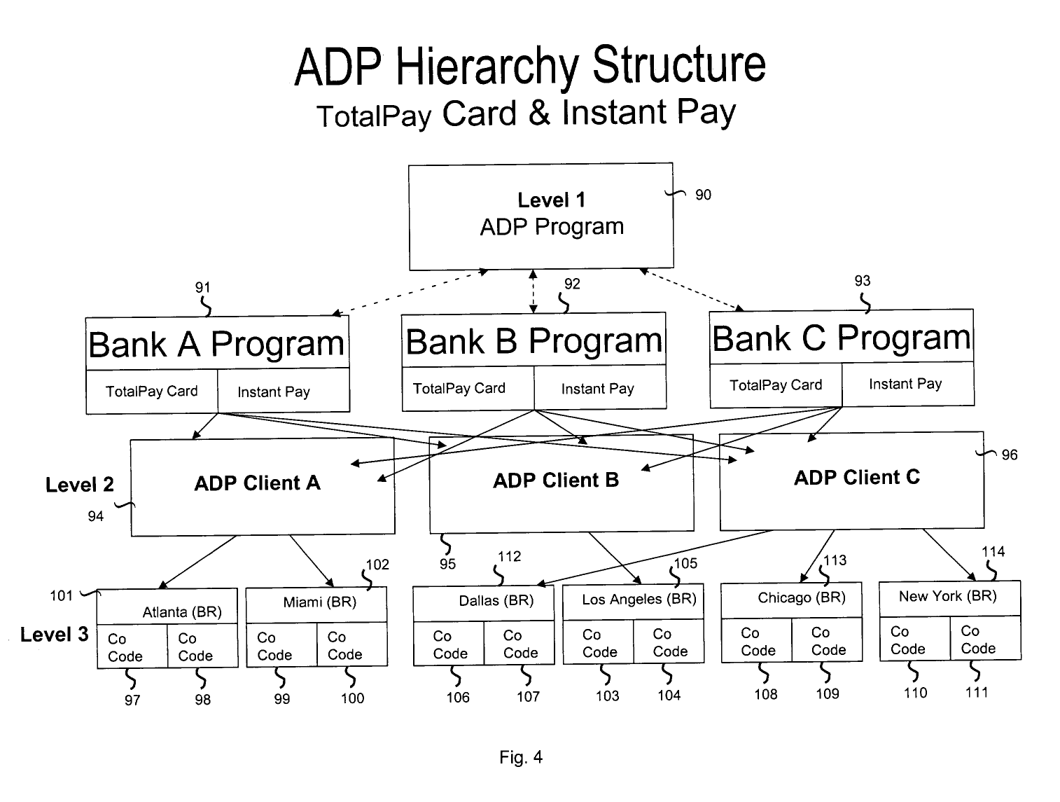

Referring now to FIG. 4, there is a shown a block diagram of one embodiment of a client hierarchy used by the payroll processor according to the system and method of the present invention. The hierarchy of FIG. 4 is used by the payroll processor to identify the relationships of various employers using the services of the payroll processor and the payroll services to be provided to the employees of those employers. This hierarchy is indicative of the stored value card services provided according to the present invention.

In the embodiment of FIG. 4, payroll processor 90 is identified at the top of the hierarchy. Payroll processor 90 establishes relationships with one or more financial institutions for the provision of stored value card services to employees of employers. In this embodiment, those financial institutions comprise Bank A Program 91, Bank B Program 92, and Bank C Program 93. The hierarchy of FIG. 4 supports delivery of the stored value and services in two forms. One form, referred to as TotalPay Card, involves issuance of a stored value card to persons for regular delivery of stored value, such as the delivery of pay or other value regularly given to employees. Generally, the card issued on TotalPay stored value accounts will be embossed with the name of the beneficiary of the stored value account. The second form, referred to as Instant Pay, involves issuance of a stored value card for purpose that may not be as regular as payroll (pay at termination, special reimbursement, etc.) or to an individual who may not regularly receive stored value. Generally, the card issued on Instant Pay stored value accounts may not be embossed with any individual's name, but instead would be accessed by an assigned personal identification number (PIN number).

Returning to FIG. 4, each of Bank A Program 91, Bank B Program 92, and Bank C Program 93 have associated sub-program identifiers (IDs) for the TotalPay Card program and the Instant Pay program as shown. Companies for whom TotalPay Card and/or Instant Pay programs are offered are shown as Client A 94, Client B 95, and Client C 96. Each of Client A 94, Client B 95, and Client C 96 may comprise a stand-alone employer or an employer having one or more employer groups. Employer groups may be related companies, divisions, branches, or any group of employees within the employer. Employer groups may have their own unique options for payroll for employees within that employer group.

As illustrated in FIG. 4, each of Client A 94, Client B 95, and Client C 96, may be serviced for the TotalPay Card and/or Instant Pay programs through any of participating banks Bank A Program 91, Bank B Program 92, and Bank C Program 93. It will be appreciated by those of skill in the art that any client in Level 2 may opt to use one or more financial institutions and the TotalPay and/or Instant Pay programs from any or all of the selected financial institutions.

Level 3 of FIG. 4 is representative of the branch/processing region and company codes assigned to each employer group within a client represented by Level 2. A branch/processing region may be a region defined by payroll processor 90 for convenience in processing payroll of employer groups located in the vicinity of such region. Specifically, in this embodiment, Client A 94 has first, second, third, and fourth Client A company codes 97, 98, 99, and 100, respectively. First and second Client A company codes 97, and 98 are within Atlanta branch/processing region 101, while third and fourth Client A company codes 99 and 100 are within Miami branch/processing region 102. Client B has first and second Client B company codes 103 and 104, respectively, both of which are within Los Angeles branch/processing region 105. Client C has first, second, third, fourth, fifth, and sixth Client C company codes 106, 107, 108, 109, 110, and 111, respectively. First and second Client C company codes 106 and 107 are within Dallas branch/processing region 112; third and fourth Client C company codes 108 and 109 are within Chicago branch/processing region 113; and fifth an sixth Client C company codes 110 and 111 are within New York branch/processing region 114.

Each employee within a company code is the next level within the hierarchy. Such employees are represented by appropriate codes such as employee number and/or social security number, for example. The hierarchy of FIG. 4 allows any one employee to choose which of the participating financial institutions shall sponsor the stored value account for that employee. In this manner, employees within a single company code are not limited to a single participating financial institution. This structure also supports smaller companies that may have only one or a small number of company codes in a limited number of branch/processing regions, as well as larger, multi-location clients with many company codes spread across multiple branch/processing regions. Also, the structure of FIG. 4 allows a client with employees across a large geographical area to opt for provision of stored value cards issued from a geographical local bank, with “local” referring to the ATM footprint of the bank.

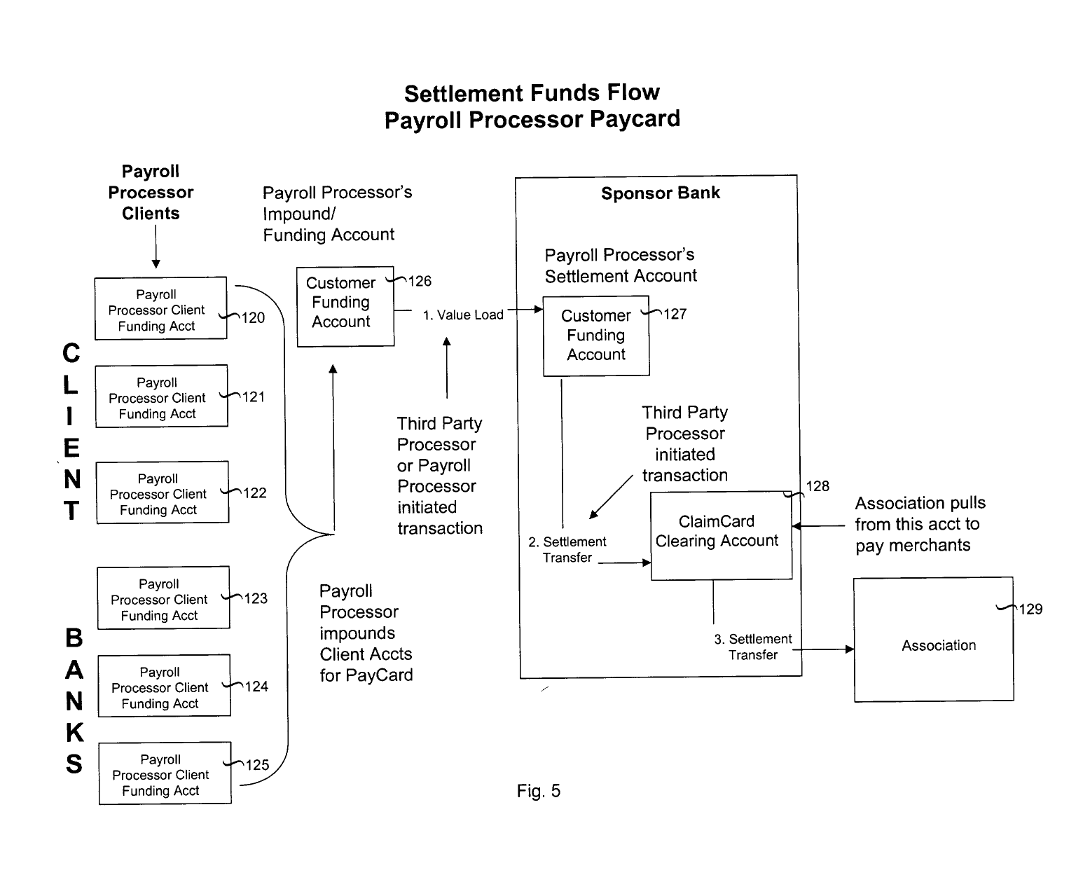

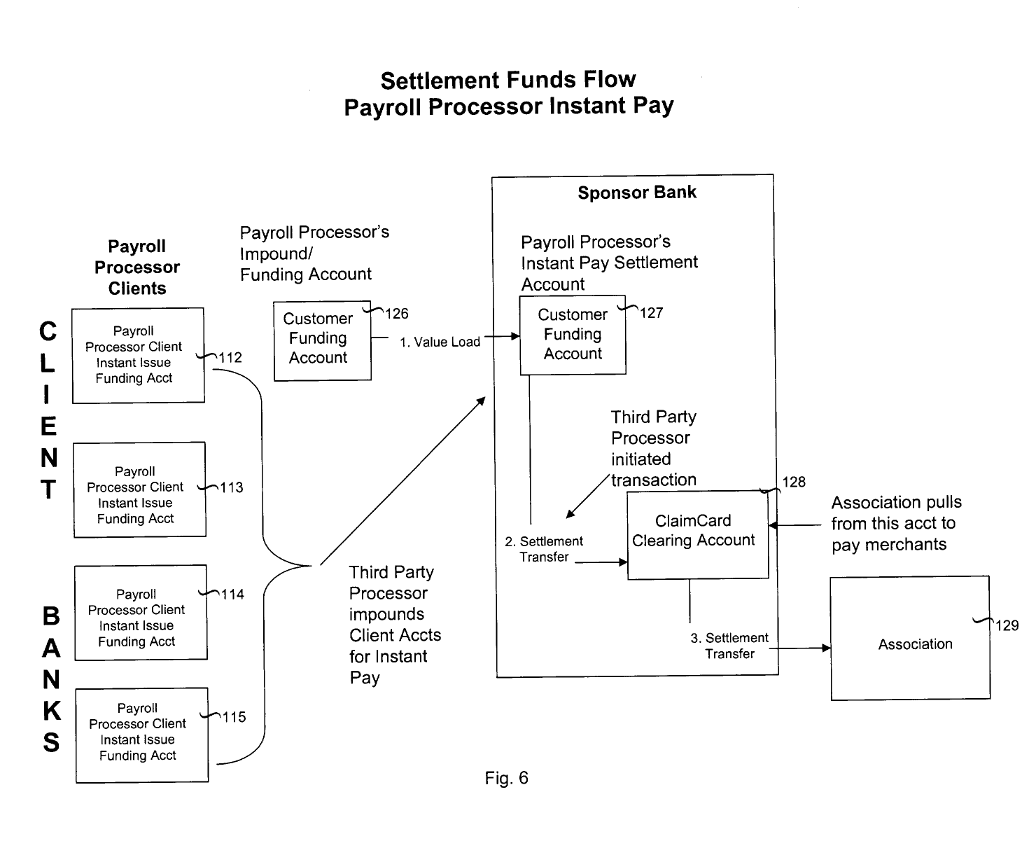

FIG. 5 and FIG. 6 show block diagrams of two embodiments of the flow of funds, impound, and settlement according the present invention. As represented by FIG. 5, funds for the stored value accounts of employees flow from employer funding accounts to a funding account held by the payroll processor. In FIG. 6, funds for the stored value accounts of employees flow from employer funding accounts to processor settlement accounts. Both embodiments are contemplated to be within the scope of the present invention.

Referring first to FIG. 5, this embodiment of the system of the present invention comprises a plurality of employer funding accounts, namely, first client funding account 120, second client funding account 121, third client funding account 122, fourth client funding account 123, fifth client funding account 124, and sixth client funding account 125. Each of the client funding accounts 120, 121, 122, 123, 124, and 125 are associated with a particular client. Such clients may be a “company” as such term is used in association with FIG. 4 above. Also, each of the client funding accounts 120, 121, 122, 123, 124, and 125 belong to the client and are established at the financial institution of the client's choice.

The system of FIG. 5 also comprises payroll processor funding account 126 into which the funds from client funding accounts 120, 121, 122, 123, 124, and 125 flow, employee stored value accounts 128 (the several employee stored value accounts for each of the employees of the clients are represented by employee stored value accounts 128), and association network 129. Employee stored value accounts 128 are controlled by the payroll processor and are established at the financial institution of the payroll processor or any participating financial institution. Association network 129 comprises a portion of transaction processing networks 34 illustrated in FIG. 1 and FIG. 2. Association network 129 operates to reduce the value of the appropriate employee stored value accounts 128 according to the monetary value of the transactions performed by the employee to whom the appropriate employee stored value accounts 128 is assigned. The combination of stored value accounts 128 may actually be a single “account” having multiple stored value accounts therein. Each stored value account has associated therewith an identifier, such as ABA Transit Number and account number, to associate the stored value account with a particular payee.

As to FIG. 6, this embodiment of the system of the present invention differs from that of FIG. 5 in the absence of payroll processor account 126 in funding the stored value accounts. Specifically, each client funds its respective client instant issue funding account 112, 113, 114, or 115. Funds flow from each client instant issue funding account 112, 113, 114, or 115 into processor settlement account 127. This embodiment may be representative of the use of a third party processor as previously discussed herein.

In the embodiment of FIG. 5, the payroll processor impounds the values of client funding accounts 120, 121, 122, 123, 124, and 125. Payroll processor may, from funding account 126, pay taxes on behalf of the clients. The payroll processor may collect interest on funds within payroll process funding account 126. Further, funds held in payroll processor's settlement account 127 may also generate interest. In fact, funds could be held in payroll processor settlement account 127 or moved into an investment account until a transaction is actually made with one of the stored value cards. The interest generated on payroll processor funding account 126 and payroll processor settlement account 127 may offset, in whole or in part, the costs incurred by the payroll processor to provide the stored value card service to its clients. Also, as shown in FIG. 5, an association will pull funds from payroll processor settlement account 127 and the payroll processor will adjust the balance of the appropriate stored value account 128 accordingly.

In the embodiment of FIG. 6, it is intended that the third party processor impound the funds from client funding accounts 112, 113, 114, and 115. In this manner, funds are deposited directly into payroll processor account 127. As in FIG. 5, in this embodiment, the association pulls funds from payroll processor settlement account 127 for transactions made with stored value cards, and the payroll processor then adjusts the balance of the appropriate stored value account 128.

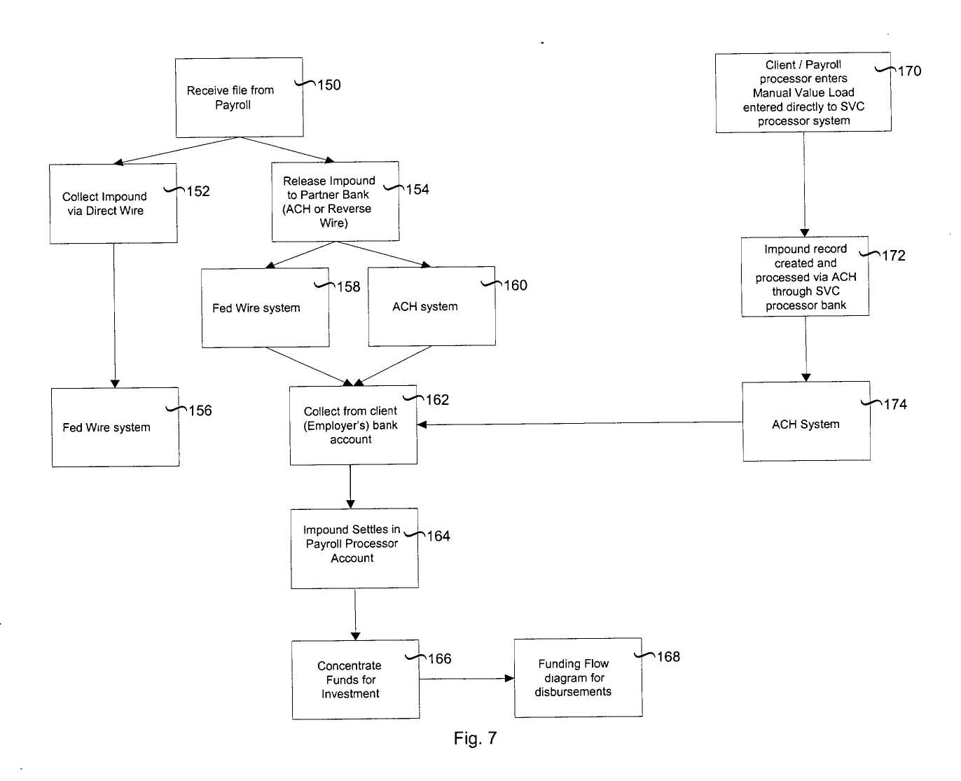

Referring now to FIG. 7, there is shown a block diagram of several embodiments of the impound flow according to the present invention. Two of the impound flows illustrated in FIG. 7 originate from payroll, with the third impound flow accommodating a manual value load of the stored value accounts according to the present invention. A manual load, in this instance, is still a part of payment from an employer to designated payees, but is done apart from the regular payroll cycle of the employer.

With regard to impounding models originating from payroll, the payroll processor receives the appropriate information about the payroll and its distribution in step 150. At this point, the payroll processor may either collect funds for that payroll from the employer directly via Direct Wire as shown in step 152 for subsequent Fed Wire transactions in step 156, or may release funds for that payroll from the employer to a participating financial institution via Automated Clearinghouse (ACH) or Reverse Wire, for example, in step 154. In this embodiment, the funds from an employer for a payroll are effectively transferred directly (through the payroll processor) to the appropriate stored value accounts for the designated employees of the employer to receive the stored value card service according to the present invention.

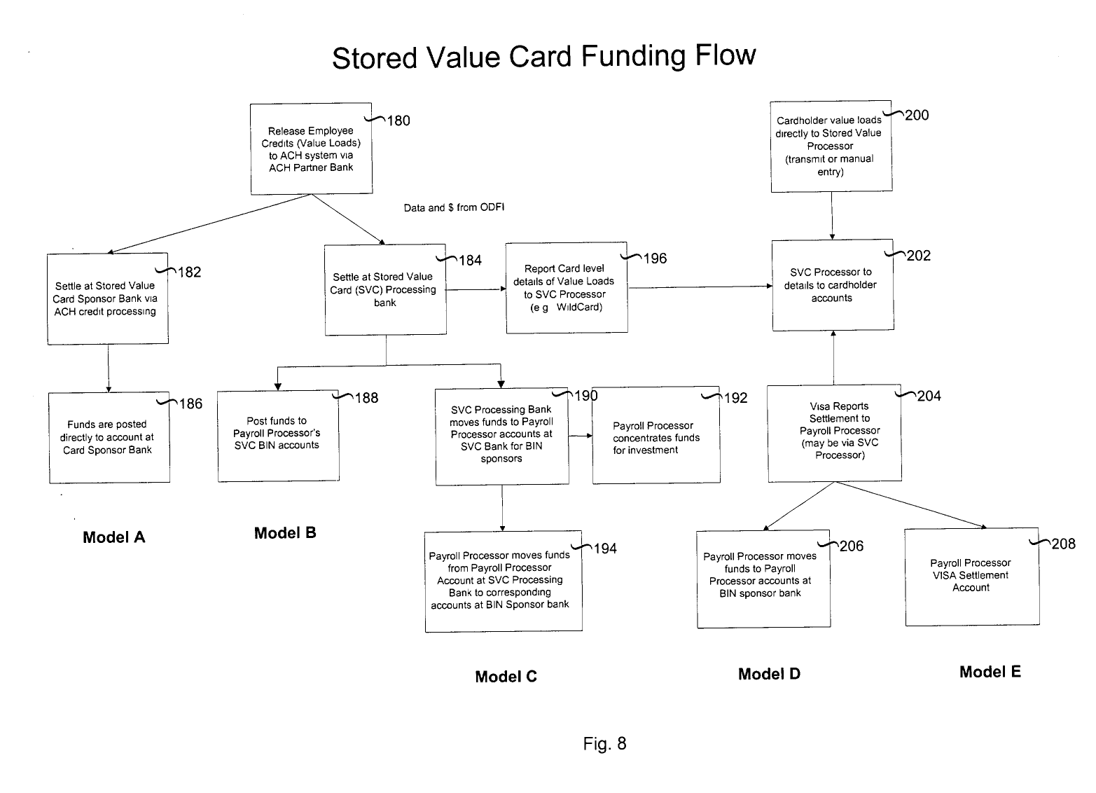

In another embodiment of the impound flow for payroll of the present invention, information from the payroll is sent by the employer and received by the payroll processor in step 150. The payroll processor then releases the impounded funds to a participating financial institution through ACH or Reverse Wire as illustrated in step 154. Then, either through Fed Wire as illustrated in step 158 or ACH as illustrated in step 160, funds are transferred to be collected from the employer's bank account for the payroll in step 162. When collected, the funds are then impounded in an account held by the payroll processor in step 164. The payroll processor may move the funds into an investment fund, as illustrated in step 166, to permit the payroll processor to benefit from the account prior to distribution. Of course, such funds are then used, as indicated in step 168, for disbursements as illustrated in connection with FIG. 8.

FIG. 7 also illustrates the impound flow for a manual value load of amounts to be posted to one or more of the stored value accounts. At step 170, either the employer or the payroll processor enters a manual value load with to the stored value card (“SVC”) processor system. An impound record is then created and processed by ACH through the SVC processor bank at step 172. Next, through the ACH system, as shown in step 174, amounts are collected from the employer's bank account in step 162.

As used herein, Direct Wire refers to a Fed Wire transaction that is initiated by an employer, and Reverse Wire refers to a Fed Wire transaction initiated by the payroll processor. It will be appreciated by those of skill in the art that the use of specific electronic transactions services, such as ACH and Fed Wire, are not limiting with regard to the present invention. These two services are widely used and accepted today and are thus incorporated as examples of such systems.

It will be further appreciated that there are numerous other possibilities for impounding funds to ultimately be posted to the stored value accounts and still be within the scope of the invention. It is possible, for example, that the payroll processor is also the SVC processor. It is also possible that the funds could be impounded by a financial institution for its benefit, or by the SVC processor for its benefit. Such variations are contemplated to be within the scope of the present invention.

Referring now to FIG. 8, there is shown a block diagram of several embodiments of the flow of funds according to the present invention. Five alternatives, namely, Model A, Model B, Model C, Model D, and Model E, are illustrated in FIG. 8. For Model A, the first step involves the release, by the employer, of employee credits (value loads) to the payroll processor system by ACH to an ACH processing financial institution or via the manual loads processing at the SVC processor. The ACH processing bank, i.e, the originating depository financial institution (ODFI), is funded via normal direct deposit funding processes used by the payroll processor. In step 182, ACH credit processing is used to settle funds at a stored value card sponsor bank in step 184. Next, funds are posted directly to an account located at the SVC sponsor bank (a bank used by the SVC processor) in step 186. In this Model A, the SVC card sponsor bank owns all further processing and risks related to the stored value card service.

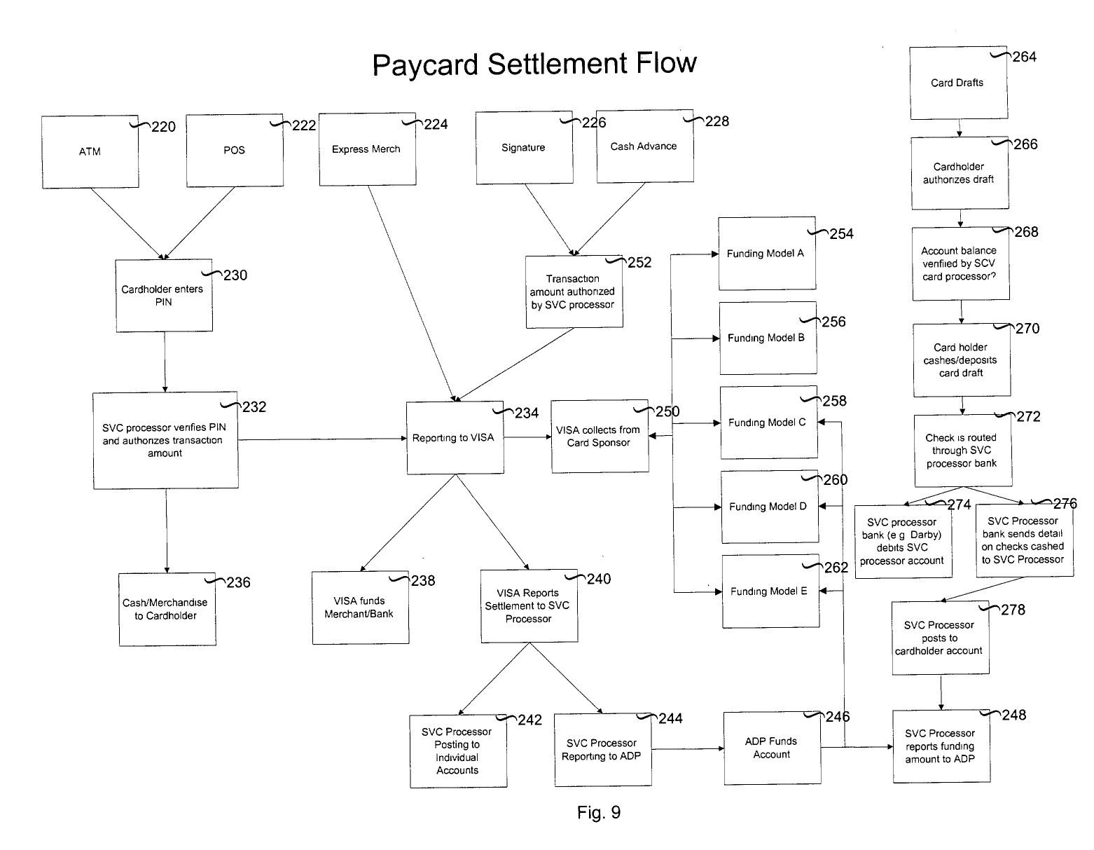

For Model B, after the employer releases the employee credits in step 180, funds are settled at the SVC processing bank in step 184. The SVC processing bank is generally the bank used by the SVC processor. The SVC processing bank may or may not be a BIN sponsor (a bank sponsoring the stored value card services through the payroll processor), but is responsible for assigning the BIN and account numbers for the stored value accounts. In the embodiment of Model B, the SVC processing bank is the BIN sponsor, and, thus, funds from the SVC processing bank are posted to the payroll processors SVC BIN account in step 188. In this Model B, the funds stay in the payroll processor's SVC BIN account until drawn down by the association settlement, as discussed in relation to FIG. 9.

In Model C, after the employee credits are released in step 180 and the funds are settled a the SVC processing bank in step 184, just as in Model B. However, because the SVC processing bank is not the BIN sponsor in this Model C, instead of posting the funds to the payroll processor's SVC BIN account, the SVC processing bank moves funds to the payroll processor's accounts at the SVC processor bank for BIN sponsors in step 190. The payroll processor's accounts at the SVC processor bank for BIN sponsors are established for each BIN processor through the SVC processing bank. Next, as required by the BIN sponsor bank, accounts are established at each sponsoring bank corresponding to the accounts at the SVC processing bank. The payroll processor moves funds from the payroll processor accounts at the SVC processing bank to corresponding payroll processor accounts at the BIN sponsor bank on the value load date in step 194.

For all Models A, B, C, D, and E, after funds are settled at the SVC processing bank, card level details of the value loads are provided by the SVC processing bank to the SVC processor as illustrated in step 196. The SVC processor may then associate details with the specific stored value accounts loaded in step 202, i.e., post the value loads received from the SVC processing bank or from manual load to the stored value accounts. The SVC processor will also post all association settlements to the stored value accounts.

Models D and E share steps with Models A, B, and C, but funds are concentrated for investment, step 192, until the association settlement occurs rather than moving funds to accounts on value load as is the case with Models A, B, and C. Both these models are based on settlement by the association recognizing the stored value card.

Returning to FIG. 8, for all models, cardholder value loads are made directly to the SVC processor in step 200. These value loads may be manually entered or transmitted directly from employer or the payroll processor to the SVC processor. Then, the SVC processor posts the value loads received from the SVC processor to the stored value accounts in step 202. In the event of a transaction recognizable by the association, the association reports the settlement to the payroll processor, the SVC processor, or the BIN sponsor bank as shown in step 204.

For Model D, the payroll processor then moves funds to the payroll processor's account at a BIN sponsor bank in step 206. In this Model D, the payroll processor uses the association reporting to identify the amount of funds to be transferred to the payroll processor's accounts at the BIN sponsor bank. In Model E, the funds are moved into a payroll processor's account at a payroll processor's partner bank (not necessarily a BIN sponsor) with the association, as shown in step 208. In this Model E, the payroll processor uses the association reporting to identify the amount of funds to be transferred to a centralized payroll processor account for association funding.

It will be appreciated by those of skill in the art that various other funding flows may be used with the present invention. It is not essentially that only those illustrated in FIG. 8 be used, nor is it a requirement that all the parties participating in these Models A, B, C, D, and E participate in the method of the present invention. For example, it is possible that employers process through their own ACH processor rather than the payroll processor processing the transactions. In addition, with respect to the participants, it is possible that the payroll processor and SVC processor are one in the same party, or that several of the banks/financial institutions be one and the same. Such variations are contemplated to be within the scope of the present invention.

Referring now to FIG. 9, there is shown a block diagram of several embodiments of settlement flow according to the present invention. Illustrated in FIG. 9 are both electronic transactions and paper transactions that may be initiated with use of the stored value card issued according to the present invention. As shown in FIG. 9, an issued stored value card may be used at ATM 220, point-of-sale (POS) device 222, express merchandise devise 224, signature station 226, cash advance station 228, and card draft station 264. These devices or stations are well-known in the art.

Considering first the flow of settlement for transactions initiated at ATM 220 or POS device 222, the holder of a stored value card enters his/her personal identification number (PIN) at such ATM 220 or POS device 222 at step 230. The party responsible for settling the accounts with the association, which, in this embodiment is the SVC processor, at step 232 verifies the PIN and authorizes the amount of the transaction. If the PIN is verified and the amount is authorized, the SVC processor reports the transaction to the association in step 234 and issues cash (as requested through ATM 220) or authorizes the delivery of merchandise (as requested through POS device 222) to the cardholder at step 236.

With regard to settlement from express merchandise station 224, the transaction is immediately reported to the association at step 234. For transactions at signature station 225 and cash advance station 228, the transaction amount is authorized by the SVC processor in step 252 prior to being reported to the association at step 234.

In the examples of settlement presented in FIG. 9 from ATM 220, POS device 224, express merchandise device 224, signature station 226, and cash advance 228, additional steps follow the reporting to the association of step 234. Specifically, after the association receives the report of step 234, the association collects funds for such transaction in step 250. Such funds are collected from the appropriate account established for settlement with the association. For funding model A 254, this account is sponsor bank settlement account 186 (See FIG. 8); for funding model B 255, this is payroll processor BIN account 188 (See FIG. 8); for funding model C 256, this is BIN sponsor bank account 194 (See FIG. 8); for funding model D, this is payroll processor at BIN sponsor bank account 206 (See FIG. 8); and for funding model E, this is payroll processor settlement account 208 (See FIG. 8).

In addition to collection of funds in step 250, the association funds the appropriate merchant or financial institution in step 238 and reports the settlement to the SVC processor in step 240. The SVC processor then posts the transaction to individual stored value accounts in step 242 and reports the transaction to the payroll processor in step 244. In Model D and in Model E, the payroll processor then funds the stored value account in step 246. Other models are funded at value load.

With regard to card drafts, the transaction is initiated by the cardholder 264. The cardholder authorizes the draft and amount at step 266. The SVC processor then verifies the account balance in step 268 and memo posts the card draft to the cardholder account. After verification of the account balance, the cardholder is then permitted to cash/deposit a card draft in step 270. The card draft is then routed through the check cashing system to the SVC processor bank in step 272. After the card draft is routed, the SVC processor bank debits the SVC processor account in step 274 and sends detailed information about the card draft to the SVC processor in step 276. The SVC processor then records the card draft to the cardholder stored value account in step 278 and reports the amount of the transaction to the payroll processor in step 248.

It will be appreciated by those of skill in the art that the roles of various parties illustrated in FIG. 9 may differ and still be within the scope of the present invention. For example, the role of the SVC processor may be performed by the payroll processor or by a third party service provider. The role illustrated by “VISA” in FIG. 9 may actually be a financial institution or another association.

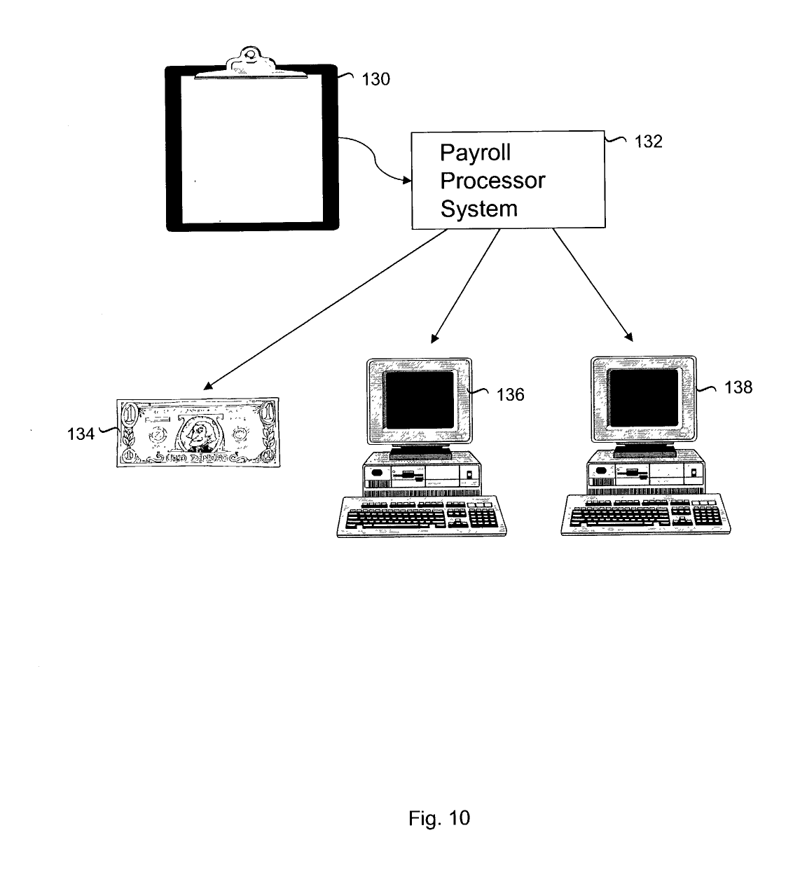

Referring now to FIG. 10, there is shown a block diagram of the activation and flow of data for an employer according to one embodiment of the present invention. A system according to the present invention represented by FIG. 10 includes input device 130, payroll processor system 132, tax and financial services system 134 (tax and financial services system 134 may be part of payroll processor system 132), employer system 136, and remote access system 138. By the use of input device 130, an employer can sign up for the services of the payroll processor, including the stored value card pay system according to the present invention. In one embodiment, input device 130 comprises a keyboard, scanner, touch screen, or other electronic device comprising a portion of employer system 52 (see FIG. 3) or of employer system 136 (see FIG. 10). Alternately, input could be provided by the employer in written, electronic, or oral form to the payroll processor or to a third party service provider. Information generally required of the employer with regard to the stored value card pay system include pertinent identification information about the employer and the financial institution(s) used by the employer for its funding account. After entry of this information, the information is transmitted (by paper or electronic form, for example) to payroll processor system 132 (akin to payroll processor system 54 of FIG. 3), and appropriate identification numbers (such as described in connection with FIG. 4) are assigned. The stored value cards issued for the identified employees may be handled by a third party service provider that creates and embosses such cards on behalf of financial institutions and/or associations.

In the embodiment of FIG. 10, payroll processor system 132 is operatively connected (such as by a network or combination of networks) to tax and financial services system 134, employer system 136, and remote access system 138. As is explained in greater detail herein, tax and financial services system 134 processes payroll information for the determination of appropriate taxes and/or other deductions. Tax and financial services system 134 may be operated by the payroll processor or a third party service provider. Further, tax and financial service system 134 and payroll processor system may comprise a single system (not shown) or multiple systems as illustrated in FIG. 10.

Employer system 136 is in communication with payroll processor system 132. Employer system 136 is illustrated as a personal computer, but may also comprise other devices having input and output capabilities for exchanging information with payroll processor 132. As previously mentioned, input device 130 may comprise a part of employer system 136.

Also in communication with the payroll processor 132 is remote access system 138. Remote access system 138 is illustrative of a system providing remote access to payroll processor 132. Remote access system 138 is optional. Further, it should be noted that the access of employer system 136 to payroll processor system 132 may be remote. Remote access system 138 is illustrated in FIG. 10 as a personal computer. It will be appreciated that remote access system 138 may comprise other hardware and/or software that is capable of communication with payroll processor system 132.

During operation of the embodiment of FIG. 10, an employer indicates with input device 130 its desire to engage the service of the payroll processor for provision of the stored value card pay services to at least one of the employer's employees. To facilitate the transfer of funds (such as is illustrated in FIG. 5 and FIG. 6), the employer must also provide information to the payroll processor via input device 130 identifying the employer's bank(s).

Upon receipt of the information sent from input device 130 to payroll processor system 132, payroll processor system 132 establishes the employer as desiring the stored value card pay services. The information is checked for accuracy and completeness. If incomplete or inaccurate, the employer is notified (via employer system 136, remote access system 138, telephone, mail, etc.). When the information for the employer is accurate and complete, codes are established, such as the codes of FIG. 4, in payroll processor system 132. In this embodiment, payroll processor system 132 then communicates appropriate information to establish the employer in tax and financial services system 134. The establishment of the employer can be verified at payroll processor system 132 or via remote access system 138.

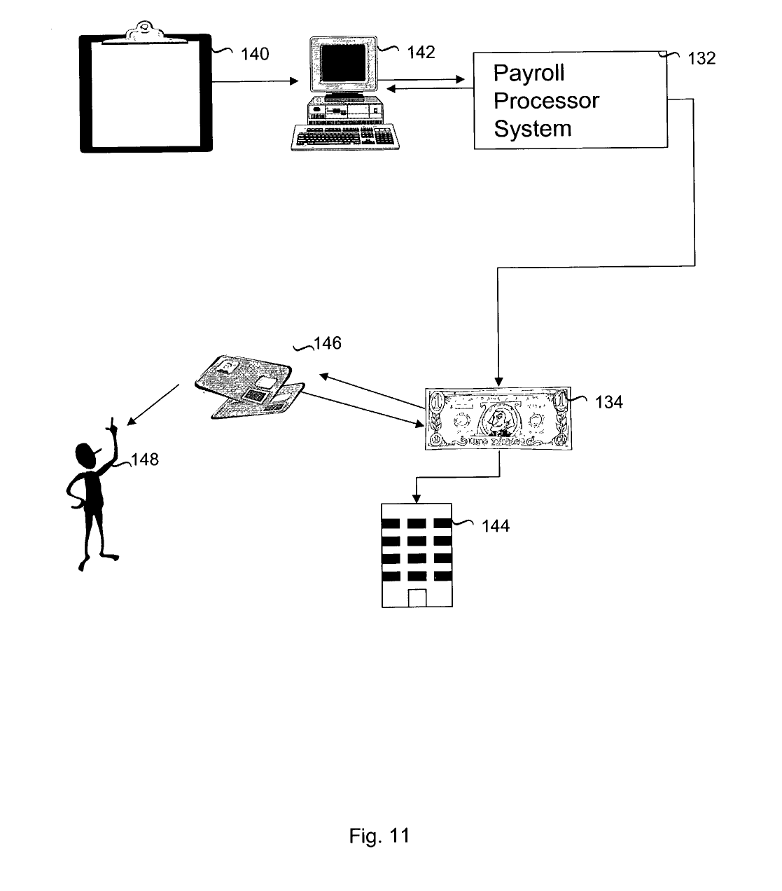

FIG. 11 shows a block diagram of the flow of employee data from an employer to service providers according to one embodiment of the present invention. To sign up employees for the stored value card pay services according to the present invention, the employer provides an employee with input device 140. Input device 140 is for the purpose of enrollment and may comprise a printed form, telephonic input, or an electronic devices such as a keyboard, mouse, scanner, touch screen, and the like. Of course, it is desired to obtain the employee's signature (whether written or electronic) via input device 140.

The embodiment of FIG. 11 also shows employer system 142 (may be the same as employer system 136 shown in FIG. 10), payroll processor system 132, tax and financial services subsystem 144, stored value cards 146, and employee(s) 148. As with the tax and financial services, the stored value cards may be manufactured and distributed by the payroll processor and/or by a third party service provider.

To complete the enrollment process of employee(s) 148, employee(s) 148 request enrollment by input device 140. From input device 140 is extracted pertinent information (name, address, employee number, social security number, etc.) that is placed on employer system 142. Employer system 142 then communicates such information to payroll processor system 132. Payroll processor system 132: (a) checks the employee information for accuracy and completeness; (b) if incomplete or inaccurate, sends a request to employer system 142 for correction or completion; and (c) if complete and accurate, establishes employee(s) 148 on payroll processor system 132 in association with the employer. For distribution of the pay to employee(s) 148 via the stored value card services according to the present invention, payroll processor system 132 sets up the stored value card pay services as a deduction from the pay of employee(s) 148. Payroll processor system 132 also send the employee information to tax and financial services system 134 and stored value card(s) 146 for employee(s) 148 are manufactured and is distributed to employee(s) 148. Alternately, a third party service provider may manufacture and/or distribute stored value cards 146. In the embodiment of FIG. 11, tax and financial services subsystem 144 is used by tax and financial services system 134 to check the provided information for accuracy and to provide notification to employee(s) 148 in the event the information provided does not reconcile with known records regarding employee(s) 148.

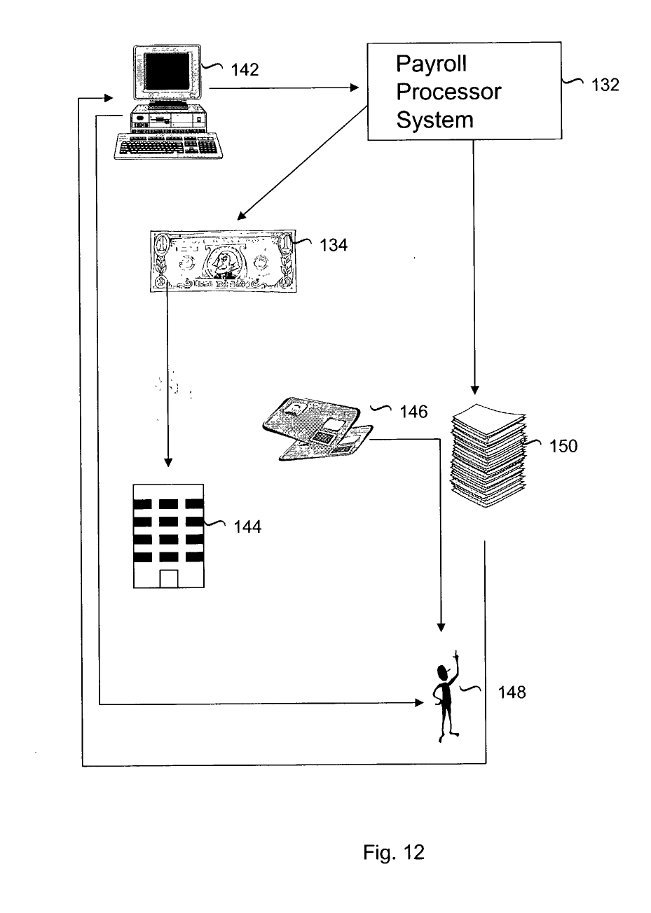

Referring now to FIG. 12, there is shown a block diagram of the flow of data from an employer to service providers according to another embodiment of the present invention. The embodiment of FIG. 12 assumes that the employer and one or more of its employee(s) 148 have been properly activated in payroll processing system 132 as discussed in association with FIG. 10 and FIG. 11, respectively. In addition to the elements in FIG. 11, FIG. 12 shows documents 150. Documents 150 may be in printed form, but are more likely to be in electronic form for communication with employer system 142. Documents 150 may comprise, for example, checks, vouchers, payroll register, AMC, employee profile cards, statistical summaries, consolidated statistical summaries, direct deposit listings, undeposited voucher reports, personnel change reports, and data files for the employer and/or its employees.

During operation, employer system 142 sends payroll information to payroll processor system 132. As previously mentioned, employer system 142 may send net pay or gross pay information to payroll system 132. Generally, it is likely that, because the payroll processor is providing the stored value card pay services to the employer, that payroll processor system 132 will determine the net pay from gross pay provided by employer system 142.

Payroll processor system 132 processes the payroll for employee(s) 148 (and, optionally, for other employees who do not receive the stored value card payroll services) to take deductions for appropriate taxes and/or benefits. Payroll processor system 132 sends deductions and net pay information to tax and financial services system 134. Tax and financial service system 134 sends information to tax and financial services subsystem 144 for verification, and transfers funds to the stored value accounts for stored value card(s) 146 for employee(s) 148. Once funds are in the stored value accounts, employee(s) 148 may use his/her respective stored value card 146 for commercial transactions accepting such cards, including but not limited to withdrawal of cash at ATMs and purchase of merchandise/services by merchants. Further detail about the handling of accounts in support of the stored value card pay service is explained herein in association with FIG. 1 and FIG. 2. Due to the portability of the stored value account, the value load transaction could take place outside the payroll processing system and tax and financial system, and simply be deposited to the payroll processor's account.

In view of the above description, it is useful to discuss both the system and method of the present invention by bringing together the foregoing disclosure. Before doing so, consider that the system and method of the present invention generally serves to deliver (make available) a monetary equivalent from a payor to at least one payee. In the embodiments of FIGS. 1 through 12, the payor was an employee and the at least one payor comprised at least one employer of the employee. In this instance, payroll due the employee served as the collateral for the stored value account established for the payor (employee).

It will be appreciated by those of skill in the art that the system and method of the present invention may comprise other payors and payees, where the payor wishes to deliver a monetary equivalent to at least one payee. Consider, for example, the desire of a parent to make funds available to his/her child, particularly when such child is a student and/or in a remote location. The system and method of the present invention is applicable to such an instance. If a third party processor, akin to the payroll processor in the employee/employer situation is used, such third party processor, multiple payors may be a service provider, perhaps providing the service for a fee based on other revenue, such as advertising revenue. Generally, the payor may simply wish to make a gift to one or more payees, without regard to whether the payor is related to any or all of the payees. For example, an employee may desire for a portion of his/her pay be delivered to the employer's child and/or employee of the employee. The employee could make such designations and multiple stored value accounts be issued and value loaded according to the employee's designations.

It will be further appreciated by those of skill in the art that more than one payor may be served by the system and method of the present invention. In the example of employers, more than one employer may wish to offer the stored value card pay service to their employees.

It will be still further appreciated that the monetary equivalent delivered to an payee under the present invention is portable in many regards. First, it is very likely that the stored value card is recognized by many locations of financial institution handling the stored value card account of an individual and by merchants with whom the financial institution has established a relationship. In one embodiment of the present invention, the stored value card delivered to the payee is also recognized by an association making it useful for numerous commercial transactions in many locations. Also, the stored value account established for a payee is one that for which funds may be deposited by more than one source. Consider, for example, the instance in which an individual has more than one employer, or a student that may be employed and also receive funds from the student's parent. Provided that the bank holding the stored value card account has an agreement with multiple payees, funding by multiple sources is possible and within the scope of the present invention.

The stored value card account for an individual does not need to be closed in the event the relationship between the payor and payee ceases. Consider, for example, the instance in which an employee has enrolled in the stored value card payment program. If the employee leaves the employ of that employer, the stored value card, if agreed to by the financial institution holding the stored value card account, is still usable. Also, in the event that individual's next employer offers a stored value card payment program and has a relationship with that same financial institution, the same stored value card account may be funded by the next employer. Further, the employee may instruct a future employer to use the stored value account for the direct deposit of pay due from that employer, without regard to whether that employer is using the stored value card service and/or any of the financial institutions that support such a stored value card service.

With regard to the method of the present invention, the following basic steps are involved. The payor provides the payroll processor with ABA Transit and Account number from which to impound funds comprised of monetary amounts to be delivered to each identified payee. The payor, at its discretion and direction, then identifies at least one payee and the monetary amount(s) to be delivered to each identified payee. The settlement account is funded with amount at least equal to the total of the identified monetary amount(s). Stored value card accounts are funded for each of the identified payees according to the amount identified for the particular payee.

When a third party processor (such as the payroll processor in the employer/employee example) is involved, it is beneficial for the third party processor to have access to and control of the transfer of the funds into the settlement account. In this manner, the third party processor is able to handle many different payees. If a third party processor is so engaged, the method further includes the steps of establishing a funding account controlled by the payor, establishing a funding account controlled by the third party processor, and funding the third party processor funding account from the funding account of the payor. In this embodiment, the settlement account is funded from the third party processor funding account.

The system of the present invention involves the provision of means to perform the steps of the present invention. In its most basic form, the requirements of the system are:

(a) Means for identifying a funding account for the payor.

(b) Means for identifying at least one of the payees and the monetary amount(s) that each of the payees is to receive. The payees and the monetary amounts are specified at the discretion and direction of the payor.

(c) Means for funding the settlement account with an amount equal to the total of the identified amounts for the identified payees.

(d) Means for funding a stored value card account for each of the identified payees. Each of the stored value card accounts is funded from the settlement account according to the amount identified for the identified payees.

Each of these “means” comprise hardware and/or software as more fully described herein.

More specifically, the system of the present invention comprises a communications network operatively connecting at least one financial institution. Such a communications network may comprise a global computer network, such as the Internet, a private network (such as may be accessible by those financial institutions that belong to an association), or any other type of network well known in the art. The system also includes at least one processor for each of the financial institutions. These financial institutions' processors are capable of accepting and receiving funds for accounts handled by the respective financial institution and are connected to the communications network. In addition to the processors used by the financial institutions, the present invention also comprises a processor for use by the payor. The payor's processor is also connected to the communications network and is used by the payor to identify the payees who have enrolled in the stored value card payroll program and the amounts that each payor is to receive. In addition, the payor processor sends data through the communications network, with such data including the identification of the payees and the amounts such payees are to receive.

The system of the present invention further includes at least one account established for the benefit of the payor at one or more of the financial institutions. These payor funding accounts are collectively funded with the identified monetary amounts to be provided to the identified payees. The system further includes stored value accounts for each of the identified payees. Each stored value account is funded through the payor funding account and has a value at least equal to the amount identified by the payor to be paid to this respective payee.

The system may be limited to a single payor processor and single financial institution processor and still be within the scope of the present invention. However, a single payor may wish to establish relationships with more than one financial institution, such as a desire of an employee to use several banks to service the needs of its employees. Alternatively, several payors may wish to provide the monetary equivalent to its payees at a single financial institution. More broadly, it is likely that several payors would desire to provide the monetary equivalent without absolutely limiting the number of financial institutions involved. Thus, to handle multiple payors and/or multiple financial institutions, a third party processor may be engaged. When a third party (such as a payroll processor when the payor is an employer and the payees are employees) is used, the system of the present invention further includes a third party processor operatively connected to the payor processor. Such connection may be through the communications network. Generally, the third party processor must be “accessible” to the payor. Such accessibility may be direct, or via the Internet or other network, for example, and is necessary to permit the payor to transmit to the third party processor the identification of payees and amounts to be paid to the payees.

In the event a third party is involved, the system may also further comprise a third party funding account established at a financial institution. This third party funding account may be funded by each of the payors, and amounts due a payee are transferred from the third party funding account to the payor settlement account and to the individual stored value accounts. Alternatively, amounts due a payee may be transferred from the third party account to the individual stored value accounts.

To permit the stored value cards for each stored value account to be useful in commerce, the system includes a transaction processing network operatively connected to the communications network. The transaction processing network is operable to accept the use of the stored value cards. Such a transaction processing network may be operated by a single financial institution, by a group of financial institutions, by an association, or any and all combinations thereof. The transaction processing network must be operably connected to the communications network so that, ultimately, the amount withdrawn from a stored value account via a commercial transaction can be withdrawn from the applicable settlement account.

In one embodiment, the payor comprises an employer and the payees comprise employees of the employer and a third party is used to process the payroll of the employer. In this embodiment, the system comprises a communications network operatively connected to at least one financial institution. The system also includes at least one financial institution processor. Each financial institution processor is for use by a financial institution providing access to accounts handled by that financial institution, and is operatively connected to the communications network. The system further includes a second processor accessible by the payor and the third party and operatively connected to the communications network. The second processor allows the payor to identify the payees who are enrolled in the stored value card payroll program and to specify an amount for that payee. The amount specified by the payor may be net pay or gross pay due the individual. If the payor specifies gross pay, then it is likely that the third party calculations net pay for an employee based on the gross pay provided by the payor. This embodiment of the system further includes a payor funding account established at one or more of the financial institutions, a payor settlement account established at one or more of the financial institutions, and stored value accounts established for each of the enrolled employees. Each stored value account is funded by the system at an amount equal to the monetary value (net pay) that is to be delivered to the employee for whom the stored value account is established.

It will be appreciated by those of skill in the art that the system and method of the present invention provide several advantages. Generally, a system and method is created for delivery of a monetary equivalent to unbanked individuals. Also, the present invention provides a means to deliver a monetary equivalent as a stored value card. Such stored value cards are not limited to use at specific merchants, but, instead, can generally be used at any merchant or ATM comprising a part of a transactions network. One or more financial institutions may establish such a transactions network, and/or one or more associations may establish such a transactions network. Through a transactions network, the payee is provided with a great deal of flexibility in commercial transactions with the stored value card.

It will also be appreciated by those of skill in the art that the system and method of the present invention, when applied to use by employers to pay its employees, is advantageous over the various methods presently used for payroll. When compared to a cash payroll system, the stored value card payroll program provides a mechanism for tracking its payroll, to collect and report taxes due on employees' income, to take deductions for benefits, and to combat fraud on the part of the employer, the supervisors, and the employees.

The present invention has several advantages over a commercial paper (check) payroll system as well. The present invention does not require distribution in the workplace, and therefore does not result in disruption for distribution (delivery) of pay to the employees. The record keeping mechanisms are not cumbersome, for all records are handled electronically. There are no misplaced or lost checks to be concerned with, nor is there any liability for fraudulently cashed checks. While the stored value cards maybe lost or stolen or used fraudulently, financial institutions and/or associations participating in the present invention may offer protections for these risks in manners similar to risk management mechanisms and methods used for debit and/or credit cards as is well-known in the art. The audit trail of the present invention not only covers the pay, but also, for the benefit of the employee, commercial transactions made with pay through the use of the stored value card. The present invention also results, as previously discussed, in a pay system that is accepted in many places. Checks often require identification requirements and may not be accepted except in a few limited locations.

Direct deposit systems do share an advantage with the present invention when compared to cash and check based systems. Specifically, each provide for electronic recordkeeping. However, as previously discussed, not all employees are banked, and thus the use of direct deposit cannot be used to deliver a monetary equivalent to all employees. The present invention is not limited to banked employees. While it is recognized that some employees may have a debit card associated with that employee's checking account, such debit cards often have limitations on their use in the same manner as checks. Also, unbanked employees do not have debit cards. These shortcomings are resolved with the stored value cards of the present invention.

The present invention does not preclude the use of third party payroll processors for determining the pay and/or distribution of the pay to employees. Instead, third party processors may be included in the system and method of the present invention. In this manner, employers can continue to enjoy the benefits its receives (and its employees receive) from the use of such payroll processors. Also, the present invention allows employers and third party processors to handle all employees by electronic means, thereby eliminating unnecessary paper records. Further, payroll processors may benefit by the accounts it establishes to service several employers. By collecting and impounding funds, interest can be collected on the accounts. It is also possible, and contemplated to be within the scope of the invention, that funds held in an account managed by the payroll processor or the employers can withhold the transfer of funds to the individual stored value accounts unless and until a commercial transaction requires the transfer of funds to cover the commercial transaction. By such mechanism, the payroll processor or the employer, respectively, benefits by the interest on such accounts.

As used herein and in the claims, the term “bank” is not intended to be limited to a bank. Instead, “bank” is to mean any of various financial institutions capable of handling stored value accounts, including but not limited to banks, credit unions, investment firms, brokerage firms, and the like. As used in the claims, the term “third party processor” may refer to a payroll processor, stored value card processor, or other third party service provider. When referring to the value of a transaction, the value of the transaction together with associated fees (such as ATM service fees) are contemplated as part of the value.

We claim:

1. A method for delivery of a monetary equivalent from an employer to at least one payee, the method comprising the steps of:
identifying at least one of the at least one payees and a monetary amount to be delivered to each of the at least one identified payees, such identification performed at the discretion and direction of the employer; and
funding a stored value account for each of the at least one identified payees, each stored value card account funded according to the monetary amount identified for the particular at least one identified payee.

2. The method of claim 1, wherein at least one of the at least one payees comprises an employee of the employer, and wherein the step of identifying the monetary amount for the employee comprises identifying funds to be transferred from the employer to the employee.

3. The method of claim 2, wherein the monetary amount for the employee comprises pay due the employee, and wherein the step of funding the stored value account for the employee comprises the step of transferring the pay due to the employee to the stored value account.

4. The method of claim 1, wherein at least one of the at least one payees comprises a designee designated by an employee of the employer, such that the step of identifying at least one payee comprises identifying the designee.

5. The method of claim 1, further comprising the step of:
establishing an employer funding account, such that the step of funding the stored value account comprises transferring funds from the employer funding account to the stored value account.

6. The method of claim 1, further comprising the steps of:
establishing an employer funding account; and
establishing an impound account held by a third party processor, such that the step of funding the stored value account comprises transferring funds from the employer funding account to the third party impound account to the stored value account.

7. The method of claim 1, further comprising the step of:
establishing a settlement account, such that the step of funding the stored value account comprises transferring funds from the settlement account to the stored value account.

8. The method of claim 1, further comprising the steps of:
issuing a stored value card for each of the stored value accounts;
using at least one of the stored value cards for a transaction that is part of a transaction network; and
reducing the value of the stored value account for the used stored value card according to the value of the transaction.

9. The method of claim 1, wherein the step of identifying the monetary amounts to be delivered to the at least one payees involves the use of a third party processor to determine the net monetary amounts to be delivered based on gross monetary amounts specified by the employer.

10. The method of claim 1, wherein the step of identifying the monetary amounts to be delivered to the at least one payees involves the use of a payroll processor to determine the net pay amounts to be delivered based on gross pay amounts specified by the employer.

11. The method of claim 1, further comprising the step of:
enrolling at least one of the at least one payees for the delivery of monetary equivalent thereto.

12. The method of claim 1, further comprising the step of:
depositing by automatic value load an additional amount into at least one stored value account.

13. The method of claim 1, further comprising the step of:
depositing by manual value load an additional amount into at least one stored value account.

14. The method of claim 1, wherein the stored value account is recognized by a plurality of financial institutions, and further including the step of:
issuing a stored value card for each of the stored value accounts.

15. A method for delivery of a monetary equivalent from an employer to a plurality of payees, the method comprising the steps of:
identifying a first and second payee from the plurality of payees;
identifying a first monetary amount to be delivered to the first payee and a first financial institution to be associated with the first payee, and identifying a second monetary amount to be delivered to the second payee and a second financial institution to be associated with the second payee; and
funding a first stored value account for the first payee at the first financial institution, the first stored value account funded according to the first monetary amount, and funding a second stored value account for the second payee at the second financial institution, the second stored value account funded according to the second monetary amount.

16. A method for delivery of a monetary equivalent from a first employer to at least one payee associated with the first employer and from a second employer to at least one payee associated with the second employer, the method comprising the steps of:
identifying at least one of the at least one payees associated with the first employer and a monetary amount to be delivered to each of the at least one identified payees associated with the first employer, such identification performed at the discretion and direction of the first employer;
identifying at least one of the at least one payees associated with the second employer and a monetary amount to be delivered to each of the at least one identified payees associated with the second employer, such identification performed at the discretion and direction of the second employer; and
funding a stored value account for each of the at least one identified payees associated with both the first and second employers, each stored value card account funded according to the monetary amount identified for the particular at least one identified payee.

17. The method of claim 16, wherein the step of identifying at least one of the at least one payees associated with the first employer further comprises identification of a financial institution for that payee, wherein the step of identifying at least one of the at least one payees associated with the second employer further comprises identification of a financial institution for that payee, such that the step of funding the stored value cards occurs at the respective designated financial institution for the respective payee.

18. The method of claim 16, further comprising the steps of:
issuing a stored value card for each of the stored value accounts;
using at least one of the stored valued cards for a transaction that is supported by a transaction network; and
reducing the value of the store value account for the used stored value card according to the value of the transaction.

19. The method of claim 16, wherein the step of identifying the monetary amounts to be delivered to the at least one payees associated with both the first and second employers involves the use of a payroll processor to determine the met pay amounts to be delivered based on gross pay amounts specified by the respective employer.

20. A system for delivery of a monetary equivalent from an employer to at least one payee, the system comprising:
means for identifying at least one of the at least one payees and a monetary amount to be delivered to each of the at least one identified payees, such identification performed at the discretion and direction of the employer; and
means for funding a stored value account for each of the at least one identified payees, each stored value card account funded according to the monetary amount identified for the particular at least one identified payee.

21. A system for delivery of a monetary equivalent from an employer to a plurality of employees, the system comprising:
means for identifying a first and second payee from the plurality of payees;
means for identifying a first monetary amount to be delivered to the first payee and a first financial institution to be associated with the first payee;
means for identifying a second monetary amount to be delivered to the second payee and a second financial institution to be associated with the second payee;
means for funding a first stored value account for the first payee at the first financial institution, the first stored value account funded according to the first monetary amount; and
means for funding a second stored value account for the second payee at the second financial institution, the second stored value account funded according to the second monetary amount.

22. A system for delivery of a monetary equivalent from a payor to at least one payee, the system comprising:
a communications network operatively connecting at least one financial institution;
at least one first processor, each of the at least one first processors accessible by one of the at least one financial institutions, and each of the at least one first processors capable of accepting and receiving funds for accounts handled by the at least one financial institution;
a second processor accessible by the payor and operatively connected to the communications network, the second processor capable of accepting input from the payor identifying at least one of the at least one payees and the monetary amounts to be delivered to each of the at least one identified payees;
a payor account established with one of the at least one financial institutions, the payor account funded with the total of the monetary amount(s) to be delivered to the at least one identified payees;
at least one stored value account for each of the at least one identified payees, each of the at least one stored value accounts funded through the payor account and having a monetary value at least equal to the amount identified by the payor to be paid to the respective payee;
at least one stored value card for each of the at least one payees, each of the at least one stored value cards having the monetary value of the corresponding at least one stored value account.

23. The system of claim 22, wherein the second processor is operated by a third party.

24. The system of claim 23, further comprising a payor network operatively connected to the second processor and accessible by the payor.

25. The system of claim 24, further comprising a third processor operatively connected to the payor network for access by the payor to the second processor.

26. The system of claim 23, wherein the third party comprises a payroll processor and collateral supporting the at least one stored value accounts comprises pay due from the payor to the at least one payee for that stored value account.

27. The system of claim 22, further comprising:
a transaction processing network operatively connected to the communications network, the transaction processing network operable to accept the use of the at least one stored value cards for commercial transactions based on the monetary value of the corresponding stored value account.

28. The system of claim 22, wherein the at least one stored value accounts is transferable between financial institutions.

29. The system of claim 22, wherein a second payor contributes to the value of one of the at least one stored value accounts.

30. A system for delivery of value of a monetary equivalent from a payor to at least one payee, the system comprising:
a communications network operatively connecting at least one financial institution;
at least one first processor, each of the at least one first processors operatively connected to the communications network for use by one of the at least one financial institutions and providing access to and accepting and receiving funds for accounts handled by that financial institution;
a second processor accessible by the payor and a third party processor, the second processor operatively connected to the communications network and capable of handling input from the payor identifying at least one of the at least one payees and the monetary amount to be received by each of the at least one identified payees;
a payor funding account established at one of the at least one financial institutions;
a settlement account established at one of the at least one financial institutions;
at least one stored value account established for each of the at least one identified payees, each stored value account funded with an amount at least equal to the monetary amount identified for the identified payee for whom the stored value account is established.

31. The system of claim 30, further comprising:
a third party funding account established at one of the at least one financial institutions.

32. The system of claim 30, further comprising:
at least one stored value card, each of the at least one stored value cards corresponding to one of the at least one stored value accounts to permit the identified payee to perform commercial transactions with the use of the stored value card.

33. The system of claim 30, wherein the payor comprises an employer and the at least one payees each comprise an employee of the employer, and wherein the payor funding account comprises an account into which the employee has deposited at least a portion of a payroll, and wherein the monetary amount identified for each of the identified payees comprise pay due the employer to that employee.

34. The system of claim 30, wherein the amount identified for at least one of the at least one identified payees comprises a gift from the payor to that identified payee.

35. The system of claim 30, wherein each of the first processors comprises a database containing the account information for accounts handled by that particular financial institution.

36. The system of claim 30, wherein the second processor comprises a database containing information about each of the at least one payees.

37. A system and method for delivery of pay from a plurality of employers to at least one of the employees of that employer, the system comprising:
a communications network operatively connecting a plurality of financial institutions;
a plurality of first processors, each of the plurality of first processors operatively connected to the communications network for use by one of the plurality of financial institutions and providing access to accounts handled by that financial institution;
a second processor accessible by the payor and a third party processor, the second processor operatively connected to the communications network, and capable of handling input from each of the plurality of employers whereby each employer in its discretion identifies at least one of the employees of that employer and the monetary amount to be received by the at least one identified employee from the employer;
an employer funding account established at one of the at least one financial institutions;
a settlement account established at one of the at least one financial institutions;
at least one stored value account established for each of the at least one identified employees of the plurality of employers, each stored value account funded with an amount at least equal to the monetary amount identified for the identified employee for whom the stored value account is established.
